(19) United States
(12) Patent Application Publication
(10) Pub. No.: US 2025/0277405 A1
(43) Pub. Date: Sep. 4, 2025

(54) Insulated Light-Blocking Window Pad Device

(71) Applicant: Raymond Mosher, Clovis, NM (US)

(72) Inventor: Raymond Mosher, Clovis, NM (US)

(21) Appl. No.: 18/918,331

(22) Filed: Oct. 17, 2024

Related U.S. Application Data
(60) Provisional application No. 63/560,243, filed on Mar. 1, 2024.

(51) Int. Cl. E06B 9/24

(52) U.S. Cl. CPC E06B 9/24; E06B 2009/2417

(57) ABSTRACT

An insulated light-blocking window pad device is provided designed to block light, reduce noise, and provide thermal insulation when secured over a window within a window frame. The device comprises a body with a front surface made of UV-resistant material and a rear surface made of an insulating material. The body also incorporates noise-reducing materials between these surfaces. The body is secured to a window using frame members, which may be telescopic and adjustable, to ensure an airtight seal, enhanced by fabric tabs attached to the edges. This configuration effectively blocks UV rays, insulates the room, and prevents noise infiltration. The device also includes decorative indicia on its surfaces, adding aesthetic value when viewed from either inside or outside the structure.

### CROSS-REFERENCE TO RELATED APPLICATION

The present application claims priority to, and the benefit of, U.S. Provisional Application No. 63/560,243, which was filed on Mar. 1, 2024, and is incorporated herein by reference in its entirety.

### FIELD OF THE INVENTION

The present invention relates generally to the field of windows. More specifically, the present invention relates to an insulated light-blocking window pad device designed to be placed over a window to provide insulating, sound-reducing, and UV-light protection properties. Accordingly, the present disclosure makes specific reference thereto. Nonetheless, it is to be appreciated that aspects of the present invention are also equally applicable to other like applications, devices, and methods of manufacture.

### BACKGROUND

Windows without curtains or blinds can be highly susceptible to allowing unwanted light to penetrate into a room, especially during times when a person desires darkness. This issue becomes particularly challenging and frustrating for individuals who work night shifts and must sleep during the day, as even the smallest amount of light can disrupt their sleep cycle. The constant intrusion of light can lead to difficulties in falling and staying asleep, which in turn can affect overall well-being and productivity. The window pad can be used with or without curtains, shades or blinds. It can be a standalone attachment or in conjunction with curtains, shades or blinds.

Moreover, windows without proper coverings are often associated with poor insulation, further exacerbating the discomfort of the room's occupants. Poorly insulated windows can allow drafts and temperature fluctuations, making it difficult to maintain a comfortable indoor environment. In the winter, cold air can seep in, while in the summer, heat can easily enter, leading to increased energy consumption as heating and cooling systems work harder to compensate. This can result in higher utility bills and a less energy-efficient home overall.

Additionally, the absence of proper window coverings not only leaves the room vulnerable to unwanted light and temperature changes but also exposes the occupants to various outside noises. These noises, whether from traffic, construction, or other sources, can be incredibly disruptive and can significantly hinder one's ability to relax, unwind, or achieve restful sleep. The combination of persistent light, noise disturbances, and poor insulation can make it nearly impossible for individuals to create a tranquil environment, thereby preventing them from getting the restorative rest they need to function optimally.

Therefore, there exists a long-felt need in the art for a window covering. There also exists a long-felt need in the art for an insulated light-blocking window pad device. More specifically, there also exists a long-felt need in the art for an insulated light-blocking window pad device that provides insulating properties to an existing window. Further, there exists a long-felt need in the art for an insulated light-blocking window pad device that provides insulating properties to an existing window and wherein the device adds noise suppression to an existing window. Finally, there exists a long-felt need in the art for an insulated light-blocking window pad device that provides insulating properties to an existing window and wherein the device adds noise suppression to an existing window and also light suppression.

The subject matter disclosed and claimed herein, in one embodiment thereof, comprises an insulated light-blocking window pad device. The device is designed to block light, reduce noise, and provide thermal insulation when secured over a window within a window frame. The device comprises a body with a front surface made of UV-resistant material and a rear surface made of an insulating material. The body also incorporates noise-reducing materials between these surfaces. The body is secured to a window using frame members, which may be telescopic and adjustable, to ensure an airtight seal, enhanced by fabric tabs attached to the edges. This configuration effectively blocks UV rays, insulates the room, and prevents noise infiltration. The device also includes decorative indicia on its surfaces, adding aesthetic value when viewed from either inside or outside the structure.

In this manner, the insulated light-blocking window pad device of the present invention accomplishes all the forgoing objectives and provides a window covering that provides insulating properties to an existing window. Further, the device adds noise suppression to an existing window. In addition, the device adds light suppression to an existing window.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an insulated light-blocking window pad device comprised of a body that can cover any shape, size, and style of any portion of a window. The body is further comprised of a front surface and a rear surface. In one embodiment, the front surface (which faces outwards towards the outside of a structure when the device is placed within a window) is comprised of a UV-blocking and/or UV-resistant material to stop UV rays from entering a room through the window the device is blocking when in position. The rear surface is preferably comprised of an insulating material. As a result, the rear surface traps hot or cold air inside the room the device is placed in and prevents said air from exiting out the window, while also preventing hot or cold air from outside the structure from entering into the room via the said window. The body (i.e., the area between the front surface and rear surface) is preferably made from a noise-reducing material that prevents noise from outside the window from entering into the room and vice versa. The front surface and/or rear surface may also be comprised of at least one indicia for decorative purposes. The device will have one-half to two inches of foam for insulation and noise reduction, depending on the wants/needs of the user. The thicker, the more noise reduction and the more heat, cold reduction it would provide. The pad is covered in a choice of material, different colors and patterns for aesthetic purposes.

The device is further secured over a window via at least one frame member that may receive at least one edge of the body. In one embodiment, the edge is received by a fastener of the frame member, such as but not limited to an adhesive fastener. In a further embodiment, the frame member may be alternatively or additionally comprised of at least one groove that receives the edge. In one embodiment, the frame member is telescopic and/or length adjustable to fit within any window size. In one embodiment, various frame members surround all edges of the body, wherein the frame members are then press-fit inside a window frame in front of a window. The frame members not only secure the body over the window, but also provide an additional seal against air and light from entering or exiting the room via the window. The device will be secured on each side by a one-inch solid, square column, on one end of each column a hole drilled approximately one inch to one and half inches deep, so that a spring with a metal rod inserted can be placed inside the drilled-out hole. The spring will extend at least one half an inch past the metal rod, so that when the column is pushed into place, and released, the spring will be pressed into the bottom of the drilled-out hole, pressing and keeping the column in place. The material may be wood, plastic or aluminum, depending on the needs and wants of the user. Wood being the least expensive, and the easiest to work with. The choice of aluminum can be either solid or hollow. The hollow column would have to have a rubber attachment added on to each end so that the aluminum column could be pressed into the frame, if it became necessary. The solid aluminum column would have a spring release the same as the plastic column.

The present invention is also comprised of a method of using the device. First, a device is provided comprised of at least one (but preferably four) frame member(s), and a body comprised of a noise-reducing material and a rear surface comprised of an insulating material. Then, the frame member can be placed inside a window frame and adjusting the frame member in length such that the frame member runs from top to bottom or left to right within the frame, wherein the frame member is secured within the frame via tension or compression (and in one embodiment, a fastener). Then, the edges of the body can each be secured to and/or received by a frame member. More specifically, at least one tab of the body is received by and/or attached to each frame member. This process can be repeated until all edges of the body are press-fit into the frame members, and the frame members are press-fit within a window frame on the interior of a structure such that the body and frame member cover the entire window.

Accordingly, the insulated light-blocking window pad device of the present invention is particularly advantageous as it provides a window covering that provides insulating properties to an existing window. Further, the device adds noise suppression to an existing window. In addition, the device adds light suppression to an existing window. In this manner, the insulated light-blocking window pad device provides a solution to improving the noise suppression, insulation, and light suppression of an existing window.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates front and rear perspective views of one potential embodiment of an insulated light-blocking window pad device of the present invention in accordance with the disclosed architecture;

FIG. 2 illustrates a perspective view of frame members of one potential embodiment of an insulated light-blocking window pad device of the present invention in accordance with the disclosed architecture;

FIG. 3 illustrates a front view of one potential embodiment of an insulated light-blocking window pad device of the present invention once installed within a window frame in accordance with the disclosed architecture; and

FIG. 4 illustrates a flowchart of a method of using one potential embodiment of an insulated light-blocking window pad device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a window covering. There also exists a long-felt need in the art for an insulated light-blocking window pad device. More specifically, there also exists a long-felt need in the art for an insulated light-blocking window pad device that provides insulating properties to an existing window. Further, there exists a long-felt need in the art for an insulated light-blocking window pad device that provides insulating properties to an existing window and wherein the device adds noise suppression to an existing window. Finally, there exists a long-felt need in the art for an insulated light-blocking window pad device that provides insulating properties to an existing window and wherein the device adds noise suppression to an existing window and also light suppression.

The present invention, in one exemplary embodiment, is comprised of an insulated light-blocking window pad device. The device is comprised of a body that can cover any shape, size, and style of any portion of a window that is further comprised of a front surface and a rear surface. In one embodiment, the front surface (which faces outwards towards the outside of a structure when the device is placed within a window) is comprised of a UV-blocking and/or UV-resistant material to stop UV rays from entering a room through the window the device is blocking when in position. The rear surface is preferably comprised of an insulating material such that the rear surface traps hot or cold air inside the room the device is placed in and prevents said air from exiting out the window, while also preventing hot or cold air from outside the structure from entering into the room via said window. The body (i.e., the area between the front surface and rear surface) is preferably made from a noise-reducing material that prevents noise from outside the window from entering into the room and vice versa. The front surface and/or rear surface may also be comprised of at least one indicia for decorative purposes.

The device is further secured over a window via at least one frame member that may receive at least one edge of the body. In one embodiment, the edge is received by a fastener of the frame member, such as but not limited to an adhesive fastener. In a further embodiment, the frame member may be alternatively or additionally comprised of at least one groove that receives the edge. In one embodiment, the frame member is telescopic and/or length adjustable to fit within any window size. In one embodiment, various frame members surround all edges of the body, wherein the frame members are then press-fit inside a window frame in front of a window. The frame members not only secure the body over the window, but also provide an additional seal against air and light from entering or exiting the room via the window.

The present invention is also comprised of a method of using the device. First, a device is provided comprised of at least one (but preferably four) frame member(s), and a body comprised of a noise-reducing material and a rear surface comprised of an insulating material. Then, the frame member can be placed inside a window frame and adjusting the frame member in length such that the frame member runs from top to bottom or left to right within the frame, wherein the frame member is secured within the frame via tension or compression (and in one embodiment, a fastener). Then, the edges of the body can each be secured to and/or received by a frame member. More specifically, at least one tab of the body is received by and/or attached to each frame member. This process can be repeated until all edges of the body are press-fit into the frame members, and the frame members are press-fit within a window frame on the interior of a structure such that the body and frame member cover the entire window.

Accordingly, the insulated light-blocking window pad device of the present invention is particularly advantageous as it provides a window covering that provides insulating properties to an existing window. Further, the device adds noise suppression to an existing window. In addition, the device adds light suppression to an existing window. In this manner, the insulated light-blocking window pad device provides a solution to improving the noise suppression, insulation, and light suppression of an existing window.

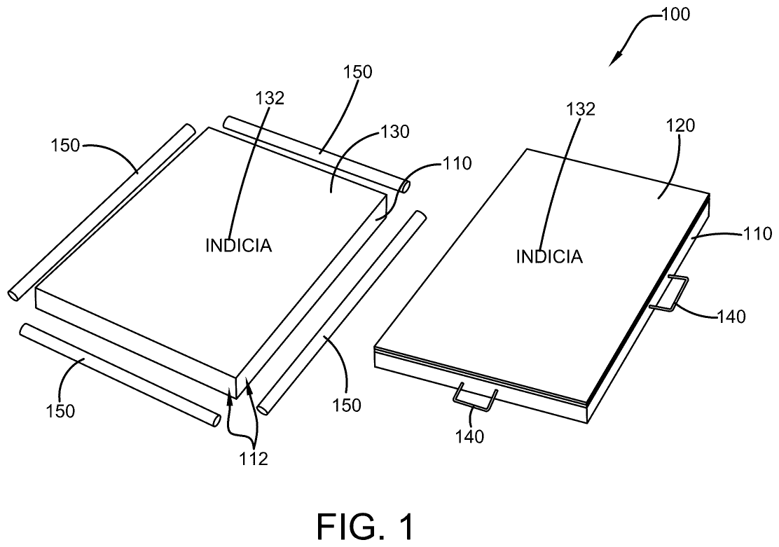

Referring initially to the drawings, FIG. 1 illustrates front and rear perspective views of one potential embodiment of an insulated light-blocking window pad device 100 of the present invention in accordance with the disclosed architecture. The device 100 is comprised of a body 110. The body 110 may be any shape in different embodiments in order to adequately cover any shape, size, and style of any portion of a window. In the preferred embodiment, the body 110 is generally rectangular in shape.

The body 110 is further comprised of a front surface 120 and a rear surface 130. The surfaces 120,130 and body 110 may be made from the same or differing materials in various embodiments. In one embodiment, the front surface 120 (which faces outwards towards the outside of a structure when the device 100 is placed within a window) is comprised of a UV-blocking and/or UV-resistant material. This material includes but is not limited to a polyester, a vinyl, a solar screen fabric, a metallic fabric, a mylar, a blackout fabric, a sheer weave fabric, etc. or any other UV-blocking/resistant material known in the art. This stops UV rays from entering a room through the window the device 100 is blocking when in position.

The rear surface 130 is preferably comprised of an insulating material. Said material includes but is not limited to a cellular fabric, a multi-layer fabric, a foam-backed fabric, a thermal lining, a wool, a blackout fabric, a felt, a thermal film, a silicone-coated fabric, or any other insulating fabric known in the art. As a result, the rear surface 130 traps hot or cold air inside the room the device 100 is placed in and prevents said air from exiting out the window, while also preventing hot or cold air from outside the structure from entering into the room via the said window. The insulating material may be any thickness to achieve various insulation properties, such as but not limited to at least one inch.

The body 110 (i.e., the area between the front surface 120 and rear surface 130) is preferably made from a noise-reducing material. Said material includes but is not limited to, a mass-loaded vinyl, a fabric, an acoustic foam, a multi-layered cellular fabric, a soundproof liner, a felt, a rubber, etc. or any other noise/sound-reducing material known in the art. In this manner, the body 110 prevents noise from outside the window from entering into the room and vice versa. The noise-reducing material may be any thickness to achieve various noise-reducing properties, such as but not limited to at least one inch.

The front surface 120 and/or rear surface 130 may also be comprised of at least one indicia 122,132 for decorative purposes. The indicia 122,132 may include but is not limited to a photograph, a scene, a pattern, a color, a simulative material, a character, an emblem, a logo, etc. As a result, the device 100 may provide a decorative effect when a user is awake with a light on in the room where the device 100 has been positioned over a window, while also providing a decorative effect to the window when viewed from outside the structure.

The device 100 is further secured over a window via at least one frame member 150 made from any material that may be rigid or flexible. The frame member 150 may be made from wood, plastic, aluminum, or any other material. The frame member 150 may be solid or hollow. The frame member 150 may receive at least one edge 112 of the body 110. In one embodiment, the edge 112 is received by a fastener 152 of the frame member 150, such as but not limited to an adhesive fastener, a rubber grommet, etc. In a further embodiment, the fastener 152 is a captured spring within the frame member 150 that presses against the edge 112 during use to secure the edge 112 to/against the frame member 150. In a further embodiment, the frame member 150 may be alternatively or additionally comprised of at least one groove 162 that receives the edge 112. In one embodiment, the frame member 150 is telescopic and/or length adjustable to fit within any window size. In one embodiment, the frame members 150 are telescopic and spring-loaded in order to remain pressed within a window frame 10 and against each edge 112.

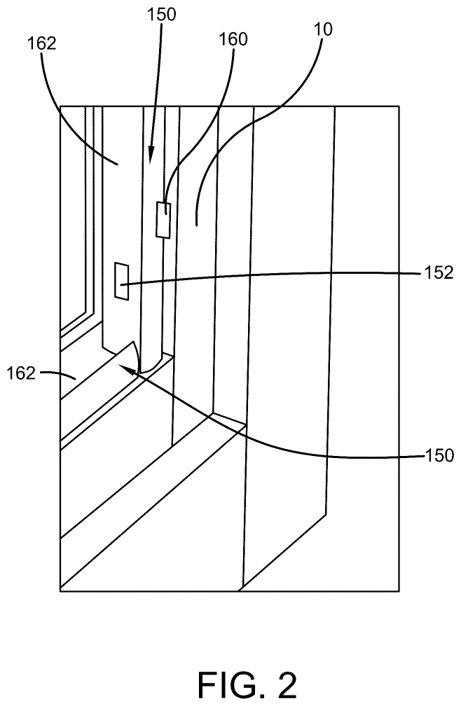

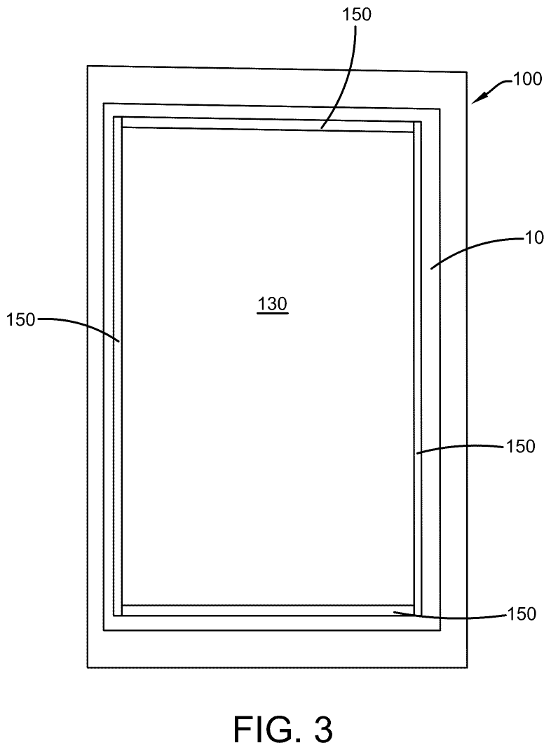

In one embodiment, various frame members 150 surround all edges 112 of the body 110, wherein the frame members 150 are then press-fit inside a window frame 10 in front of a window, as seen in FIG. 2 and FIG. 3. The frame members 150 not only secure the body 110 over the window, but also provides an additional seal against air and light from entering or exiting the room via the window, as best seen in FIG. 3. In another embodiment, the frame members 150 may be further secured to (and inside) a window frame 10 via at least one fastener 160, such as but not limited to an adhesive fastener. In an alternative embodiment, the frame members 150 attach to the outside of a window frame 10 via the fastener 160.

Each edge 112 of the body 110 may further be comprised of at least one fabric tab 140 of any length/size. Each tab may be received by each frame member 150 to further ensure an air-tight seal between the body 110 and frame members 150. In one embodiment, the tab 140 may be fully or partially received by the groove 162.

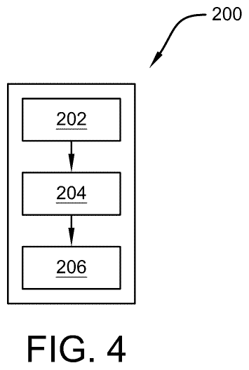

The present invention is also comprised of a method of using 200 the device 100, as seen in FIG. 4. First, a device 100 is provided comprised of at least one (but preferably four) frame member(s) 150, and a body 110 comprised of a noise-reducing material and a rear surface 130 comprised of an insulating material [Step 202]. Then, the frame member 150 can be placed inside a window frame 10 and adjusting the frame member 150 in length such that the frame member 150 runs from top to bottom or left to right within the frame, wherein the frame member 150 is secured within the frame 10 via tension or compression (and in one embodiment, a fastener 160) [Step 204]. Then, the edges 112 of the body 110 can each be secured to and/or received by a frame member 150 [Step 202]. More specifically, at least one tab 140 of the body 110 is received by and/or attached to each frame member 150 [Step 204]. This process can be repeated until all edges 112 of the body 110 are press-fit into the frame members 150, and the frame members 150 are press-fit within a window frame 10 on the interior of a structure such that the body 110 and frame member 150 cover the entire window [Step 206].

The device 100 can be used with or without curtains, shades, or blinds.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “insulated light-blocking window pad device” and “device” are interchangeable and refer to the insulated light-blocking window pad device 100 of the present invention.

Notwithstanding the forgoing, the insulated light-blocking window pad device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the insulated light-blocking window pad device 100 as shown in the FIGS. are for illustrative purposes only, and that many other sizes and shapes of the insulated light-blocking window pad device 100 are well within the scope of the present disclosure. Although the dimensions of the insulated light-blocking window pad device 100 are important design parameters for user convenience, the insulated light-blocking window pad device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An insulated light-blocking window pad device comprising:
a body comprised of a noise-reducing material, an insulated rear surface, and a tab; and
a frame member comprised of a groove.

2. The insulated light-blocking window pad device of claim 1, wherein the groove is comprised of a first fastener.

3. The insulated light-blocking window pad device of claim 2, wherein the first fastener is comprised of an adhesive fastener.

4. The insulated light-blocking window pad device of claim 1, wherein the body is comprised of a rectangular shape.

5. The insulated light-blocking window pad device of claim 1, wherein the insulated rear surface is comprised of a cellular fabric, a multi-layer fabric, a foam-backed fabric, a thermal lining, a wool, a blackout fabric, a felt, a thermal film, or a silicone-coated fabric.

6. The insulated light-blocking window pad device of claim 1, wherein the frame member is comprised of a length-adjustable frame member.

7. The insulated light-blocking window pad device of claim 1, wherein the frame member receives an edge of the body.

8. An insulated light-blocking window pad device comprising:
a body comprised of a noise-reducing material, an insulated rear surface, a UV-resistant front surface, and a tab; and
a telescopic frame member comprised of a groove.

9. The insulated light-blocking window pad device of claim 8, wherein the groove is comprised of a first fastener.

10. The insulated light-blocking window pad device of claim 9, wherein the first fastener is comprised of an adhesive fastener.

11. The insulated light-blocking window pad device of claim 8, wherein the telescopic frame member is comprised of a second fastener.

12. The insulated light-blocking window pad device of claim 11, wherein the second fastener is comprised of an adhesive fastener.

13. The insulated light-blocking window pad device of claim 8, wherein the front surface is comprised of a first indicia.

14. The insulated light-blocking window pad device of claim 8, wherein the rear surface is comprised of a first indicia.

15. The insulated light-blocking window pad device of claim 8, wherein the UV-resistant front surface is comprised of a polyester, a vinyl, a solar screen fabric, a metallic fabric, a mylar, a blackout fabric, or a sheer weave fabric.

16. The insulated light-blocking window pad device of claim 8, wherein the noise-reducing material is comprised of a mass-loaded vinyl, a fabric, an acoustic foam, a multi-layered cellular fabric, a soundproof liner, a felt, or a rubber.

17. A method of using an insulated light-blocking window pad device, the method comprising the following steps:
providing an insulated light-blocking window pad device comprised of a frame member and a body comprised of a noise-reducing material and a rear surface comprised of an insulating material;
placing the frame member inside a window frame and adjusting a length of the frame member such that it is secured within the window frame via tension or compression; and
securing an edge of the body to the frame member such that the body and the frame member cover a window that is surrounded by the window frame.

18. The method of using an insulated light-blocking window pad device of claim 17, wherein the rear surface is comprised of an indicia.

19. The method of using an insulated light-blocking window pad device of claim 17, wherein the frame member is comprised of a telescopic frame member.

20. The method of using an insulated light-blocking window pad device of claim 17, wherein the body is comprised of a front surface comprised of a UV-resistant material.
